(19) United States
(12) Patent Application Publication
(10) Pub. No.: US 2007/0069615 A1
(43) Pub. Date: Mar. 29, 2007

(54) SURFACE LIGHT SOURCE DEVICE

(75) Inventors: Hae Soo HA, Suwon-si (KR); Seog Hyun CHO, Seoul (KR); Kyeong Taek JUNG, Suwon-si (KR); Hyun Seok KIM, Suwon-si, Gyeonggi-do (KR)

Correspondence Address: BEYER WEAVER LLP, P.O. BOX 70250, OAKLAND, CA, 94612-0250, US

(73) Assignee: SAMSUNG CORNING CO., LTD., Suwon-si (KR)

(21) Appl. No.: 11/533,503

(22) Filed: Sep. 20, 2006

(30) Foreign Application Priority Data
Sep. 26, 2005 (KR) 10-2005-0089328
Aug. 28, 2006 (KR) 10-2006-0081790

(51) Int. Cl. H01J 1/62; H01J 5/16; H01J 61/40

(52) U.S. Cl. 313/112; 313/489; 313/635

(57) ABSTRACT

There is provided a surface light source device comprising upper and lower substrates adhered to each other in order to form a discharge space, a reflection layer and a lower fluorescent layer stacked on an upper surface of the lower substrate, and an upper fluorescent layer stacked on a lower surface of the upper substrate, wherein the reflection layer has a thickness of 40 to 120 μm, the lower fluorescent layer has a thickness of 10 to 60 μm, and the upper fluorescent layer has a thickness of 10 to 25 μm, and the device further comprises a first ion shield layer interposed between the upper substrate and the upper fluorescent layer, for blocking Na⁺ ions from being eluted from the upper substrate.

### BACKGROUND OF THE INVENTION

1. Technical Field

The present invention relates to a fluorescent lamp, and more particularly, to a surface light source device which is used in a liquid crystal display (LCD) device and includes a discharge space with a plurality of stripe-shaped channels.

2. Discussion of Related Art

In general, liquid crystals have both electrical and optical properties. The liquid crystals change an orientation according to the direction of an electric field due to the electrical property and change optical transmittance according to the orientation due to the optical property.

A liquid crystal display device displays an image, using the electrical and optical properties of the liquid crystal. Since a liquid crystal display device is very small and light, compared to a cathode-ray tube (CRT), it is widely used in portable computers, communication devices, liquid crystal televisions, and space and aviation industries.

In a surface light source device, a discharge space is formed between an upper substrate and a lower substrate, a discharge gas is injected into the discharge space, and a voltage is applied to the discharge space. Ultraviolet ray, which is emitted from the discharge gas excited by the applied voltage, generates visible ray by exciting fluorescent layers stacked on inner surfaces of the upper and lower substrates.

Of the methods for forming a multi-channel discharge space, a method is carried out by interposing spacers between an upper substrate and a lower substrate and bonding the edge of the upper substrate and the edge of the lower substrate by using low-temperature sealing glass. Another method is performed by molding an upper substrate or a lower substrate so as to have a discharge space in a predetermined shape by using a metal cast, and bonding the upper or lower substrate.

After discharge gas, such as argon (Ar) or neon (Ne), and a mercury (Hg) gas are injected into the discharge space formed as above, the discharge space is sealed.

However, the aforementioned conventional surface light source device has problems in that its lifetime is rapidly shortened because of a reduced amount of organic mercury and a deteriorated fluorescent layer.

Specifically, the upper and lower substrates are composed of soda lime glass containing about 4 to 15% of Na⁺ions. Thus, when the Na⁺ions react to the mercury, amalgam is formed, thereby reducing the amount of the organic mercury in the discharge space and shortening the lifetime of the fluorescent lamp.

Furthermore, since the conventional surface light source device has insufficient luminance, a method for improving the luminance is required.

### SUMMARY OF THE INVENTION

Therefore, the present invention is directed to provide a surface light source device with improved luminance and increased lifetime.

According to an aspect of the present invention, there is provided a surface light source device including upper and lower substrates adhered to each other in order to form a discharge space, a reflection layer and a lower fluorescent layer stacked on an upper surface of the lower substrate, and an upper fluorescent layer stacked on a lower surface of the upper substrate, wherein the reflection layer has a thickness of 40 to 120 μm, the lower fluorescent layer has a thickness of 10 to 60 μm, and the upper fluorescent layer has a thickness of 10 to 25 μm, and the device further includes a first ion shield layer interposed between the upper substrate and the upper fluorescent layer for blocking Na⁺ions from being eluted from the upper substrate.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1 is a perspective view illustrating a surface light source device according to a first embodiment of the present invention;

FIG. 2 is a cross-sectional view illustrating the surface light source device taken along line A-A′ of FIG. 1;

FIG. 3 is an expanded view illustrating a portion B of the surface light source device shown in FIG. 2;

FIG. 4 illustrates a backlight unit including the surface light source device shown in FIG. 1;

FIG. 5 is a cross-sectional view illustrating a surface light source device according to a second embodiment of the present invention; and

FIG. 6 is an expanded view illustrating a portion C of the surface light source device shown in FIG. 5.

### DETAILED DESCRIPTION OF THE INVENTION

The present invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided as teaching examples of the invention. Like numbers refer to like element.

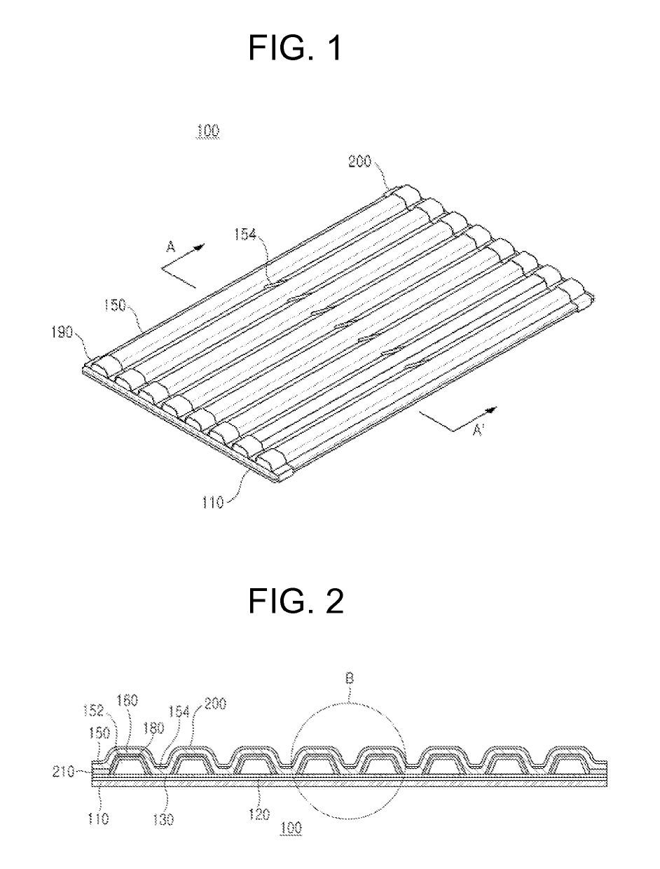

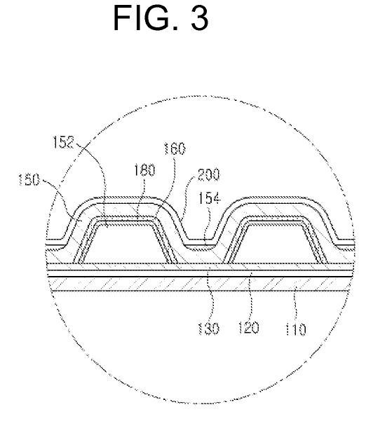

FIG. 1 is a perspective view illustrating a surface light source device according to a first embodiment of the present invention, FIG. 2 is a cross-sectional view illustrating the surface light source device taken along line A-A′ of FIG. 1, and FIG. 3 is an expanded view illustrating a portion B of the surface light source device.

The surface light source device 100 includes a lower substrate 110 and an upper substrate 150 which form an airtight discharge space 152 therebetween, a sealing member 210 interposed between the lower and upper substrates 110 and 150 for adhering between the lower and upper substrates 110 and 150 and sealing the discharge space 152, and a pair of electrodes 190 and 200 for applying a voltage across a flat fluorescent lamp 100 so that discharge occurs in the discharge space 152. For generation of ultraviolet ray by discharge, discharge gas and mercury gas are injected into the discharge space 152.

Each of the lower and upper substrates 110 and 150 is in a rectangular plate shape, and the discharge space 152 includes a plurality of channels arranged in parallel and partially connected to one another. To form the discharge space 152, the upper substrate 150 may be formed with a plurality of channels by partially vacuum-inhaling a flat substrate. In order for the channels to be partially connected to one another in the discharge space 152, a through-hole 154 may be formed at each partition between two adjacent channels. Each of the lower and upper substrates 110 and 150 is formed of transparent glass. Alternatively, for the connection between the channels, the discharge space may have a serpentine structure.

In the discharge space 152, a reflection layer 120 and a lower fluorescent layer 130 are sequentially stacked on the upper surface of the lower substrate 110.

The reflection layer 120 is stacked on the upper surface of the lower substrate 110 so that visible ray is emitted only onto the upper surface of the surface light source device 100. The reflection layer 120 may be formed by making a high-reflectance mixture in a slurry state and coating the surface of the lower substrate 110 with the mixture. The reflection layer 120 may have a thickness of 40

to 120 μm. When the reflection layer 120 has a thickness being less than 40 μm, the visible ray occurs to transmit through the reflection layer 120 and the lower substrate 110, causing unnecessary light loss. When the reflection layer 120 has a thickness being greater than 120 μm, organic impurities remain within the reflection layer 120 after heat treatment is performed when the reflection layer 120 is formed, deteriorating discharge properties of the device and shortening the lifetime thereof.

The lower fluorescent layer 130 is excited by the ultraviolet ray generated by the discharge within the discharge space 152, generating visible ray. The lower fluorescent layer 130 may have a thickness of 10 to 60 μm. If the lower fluorescent layer 130 has a thickness being less than 10 μm, the ultraviolet ray which is not absorbed into the lower fluorescent layer 130 remains. If the lower fluorescent layer 130 has a thickness being greater than 60 μm, the ultraviolet ray may not reach a lower portion of the lower fluorescent layer 130.

A first ion shield layer 160 and an upper fluorescent layer 180 are sequentially stacked on the lower surface of the upper substrate 150.

The first ion shield layer 160 blocks Na⁺ions from being eluted from the upper substrate 150 formed of glass containing a number of Na⁺ions during a discharge process. The first ion shield layer 160 may be formed of, for example, SiO₂ and have a thickness of 3 to 200 nm (30 to 2000 Å). The first ion shield layer 160 may be formed by directly spraying SiO₂ on the upper substrate 150 or coating the upper substrate 150 with SiO₂ in a sputtering process.

The upper fluorescent layer 180 is excited by the ultraviolet ray generated by the discharge in the discharge space 152, generating visible ray. The upper fluorescent layer 180 may have a thickness of 10 to 25 μm for optimal luminescence efficiency.

The sealing members 210 are positioned at the edges of the flat fluorescent lamp 100 for adhesion between the lower and upper substrates 110 and 150 and are interposed between opposite and parallel adhered surfaces of the lower and upper substrates 110 and 150 positioned at the edges of the surface light source device 100.

A pair of electrodes 190 and 200 to apply a voltage are positioned at both ends of the discharge space 152, and a discharge gas and a small amount of mercury are injected into the discharge space 152. If the voltage is applied between the electrodes 190 and 200, discharge occurs in the discharge space 152, to excite the lower and upper fluorescent layers 130 and 180, thereby generating visible ray. The generated visible ray is emitted through the upper surface of the surface light source device 100.

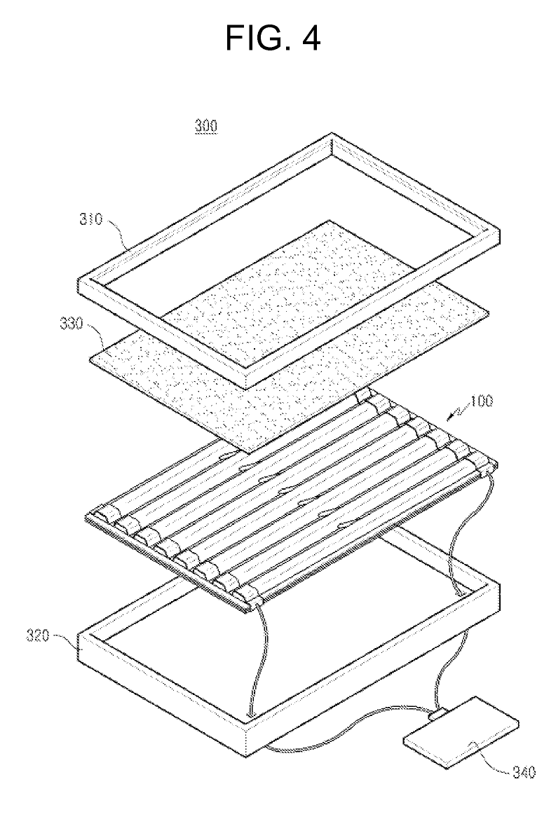

FIG. 4 illustrates a backlight unit including the surface light source device shown in FIG. 1. The backlight unit 300 includes upper and lower cases 310 and 320, an optical sheet 330, an inverter 340, and a surface light source device 100.

The lower case 320 has a receiving space in which the surface light source device 100 is safely mounted. The upper case 310 is combined with the lower case 320 so that the surface light source device 100 and the optical sheet 330 are safely positioned thereinside.

The inverter 340 generates a voltage to drive the surface light source device 100. The discharge voltage is applied between the electrodes 190 and 200 of the surface light source device 100 by a wire.

The optical sheet 330 may include a diffusion plate for uniformly diffusing the light emitted from the surface light source device 100 toward a liquid crystal panel (not shown), and a prism for directionality of the diffused light.

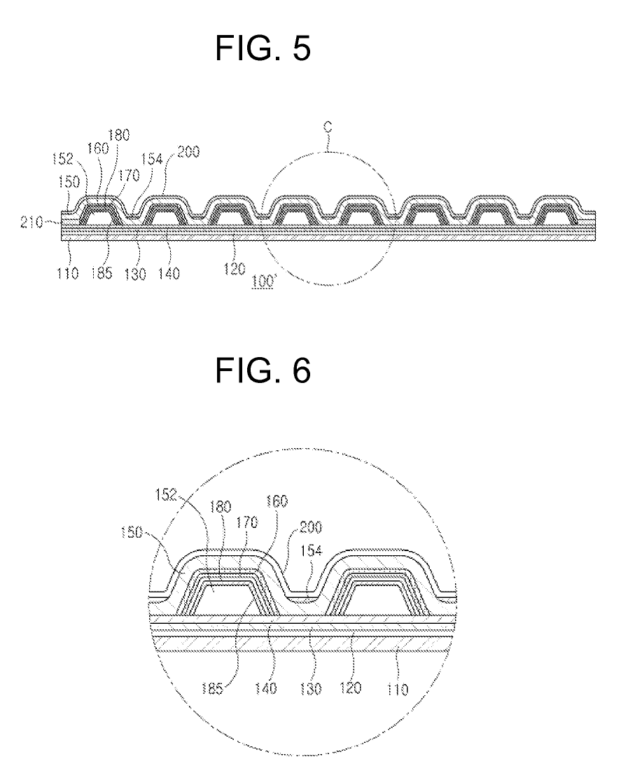

FIG. 5 is a cross-sectional view illustrating a surface light source device according to a second embodiment of the present invention, and FIG. 6 is an expanded view illustrating a portion C of the surface light source device of FIG. 5. The surface light source device 100 is similar to the surface light source device illustrated in FIGS. 1 to 3, except that the surface light source device 100 of FIG. 5 further includes a second ion shield layer 170, and first and second short wavelength ultraviolet ray blocking layers 140 and 185. Accordingly, an overlapping description thereof will not be further presented, and same reference numbers are used for denoting the same elements.

In the discharge space 152, a reflection layer 120, a lower fluorescent layer 130, and a first short wavelength ultraviolet ray blocking layer 140 are sequentially stacked on the upper surface of a lower substrate 110.

The first short wavelength ultraviolet ray blocking layer 140 blocks ultraviolet ray having short wavelengths (particularly, 185 nm) smaller than excitation wavelength (=253.7 nm) among the ultraviolet rays produced in the discharge space 152, thereby preventing the lower fluorescent layer 130 from being deteriorated by the short wavelength ultraviolet ray.

The first short wavelength ultraviolet ray blocking layer 140 may be composed of Y₂0₃ and have a thickness of 0.1 to 5 μm. When the first short wavelength ultraviolet ray blocking layer 140 has a thickness exceeding the above-described range, impurities are likely to be created inside the discharge space 152.

First and second ion shield layers 160 and 170, an upper fluorescent layer 180, and a second short wavelength ultraviolet ray blocking layer 185 are sequentially stacked on the lower surface of the upper substrate 150. The first and second ion shield layers 160 and 170 block Na⁺ions from being eluted from the upper substrate 150 formed of glass containing a number of Na⁺ions during the discharge process. The first ion shield layer 160 may be composed of SiO₂ and have a thickness of 3 to 200 nm (30 to 2000 Å). The second ion shield layer 170 may be composed of Y₂O₃ and have a thickness of 0.1 to 5 μm.

The second short wavelength ultraviolet ray blocking layer 185 blocks the ultraviolet ray having short wavelengths smaller than an excitation wavelength among the ultraviolet ray produced in the discharge space 152, thereby preventing the upper fluorescent layer 180 from being deteriorated by the short wavelength ultraviolet ray. The second short wavelength ultraviolet ray blocking layer 185 may be composed of Y₂0₃ and have a thickness of 0.1 to 5 μm.

As described above, the surface light source device according to the present invention includes the fluorescent layer and the reflection layer each formed in an optimal thickness, thereby greatly improving luminance and lifetime of the surface light source device.

In addition, the surface light source device according to the present invention includes at least one blocking layer, thereby increasing the lifetime of the surface light source device.

The invention has been described using preferred exemplary embodiments. However, it is to be understood that the scope of the invention is not limited to the disclosed embodiments. On the contrary, the scope of the invention is intended to include various modifications and alternative arrangements within the capabilities of persons skilled in the art using presently known or future technologies and equivalents. The scope of the claims, therefore, should be accorded the broadest interpretation so as to encompass all such modifications and similar arrangements.

What is claimed is:

1. A surface light source device comprising upper and lower substrates adhered to each other to form a discharge space, a reflection layer and a lower fluorescent layer stacked on an upper surface of the lower substrate, and an upper fluorescent layer stacked on a lower surface of the upper substrate, wherein:
the reflection layer has a thickness of 40 to 120 μm, the lower fluorescent layer has a thickness of 10 to 60 μm, and the upper fluorescent layer has a thickness of 10 to 25 μm, and
the device further comprises a first ion shield layer interposed between the upper substrate and the upper fluorescent layer, for blocking Na⁺ ions from being eluted from the upper substrate.

2. The device of claim 1, wherein each of the upper and lower substrates is composed of glass containing 4 to 15% of Na⁺ ions.

3. The device of claim 2, wherein at least one of the upper and lower substrates is composed of soda lime glass.

4. The device of claim 1, wherein the first ion shield layer is composed of SiO₂.

5. The device of claim 4, wherein the first ion shield layer has a thickness of 3 to 200 nm.

6. The device of claim 1, further comprising a short wavelength ultraviolet ray blocking layer which is stacked on the upper and/or lower fluorescent layers, for blocking the ultraviolet ray having short wavelengths smaller than an excitation wavelength.

7. The device of claim 6, wherein the short wavelength ultraviolet ray blocking layer is composed of Y₂O₃.

8. The device of claim 7, wherein the short wavelength ultraviolet ray blocking layer has a thickness of 0.1 to 5 μm.

9. The device of claim 1, further comprising a second ion shield layer interposed between the first ion shield layer and the upper fluorescent layer, for blocking Na⁺ ions from being eluted from the upper substrate, together with the first ion shield layer.

10. The device of claim 9, wherein the second ion shield layer is composed of Y₂O₃.

11. The device of claim 10, wherein the second ion shield layer has a thickness of 0.1 to 5 μm.
